(19) United States
(12) Patent Application Publication
(10) Pub. No.: US 2018/0282181 A1
(43) Pub. Date: Oct. 4, 2018

(54) Fresh water and salable energy without environmental harm1

(71) Applicant: William P. Taylor, Laguna Woods, CA (US)

(72) Inventor: William P. Taylor, Laguna Woods, CA (US)

(21) Appl. No.: 15/530,959

(22) Filed: Mar. 30, 2017

(51) Int. Cl. C02F 1/04; B01D 1/00; B01D 1/02; B01D 5/00; F01K 7/16; F01K 11/02; F01K 3/18

(52) U.S. Cl. CPC C02F 1/043; B01D 1/0011; B01D 1/02; B01D 5/0006; C02F 2103/08; B01D 5/006; F01K 7/16; F01K 11/02; F01K 3/18; B01D 5/0039

(57) ABSTRACT

Three embodiments of an invention are disclosed in which sea water undergoes a desalination process accompanied by production of salable energy of value greater than the cost of the fossil fuel required, and which discharges brine to the sea at a temperature and salinity harmless to sea life.

### REFERENCES

1. U. S. patent Frank U.S. Pat. No. 9,056,261B2 Water Desalination System
2. Baumeister, Mark's Mechanical Engineer's Handbook, Sixth Edition
3. H. G. Deming, WATER, The Fountain of Opportunity. Oxford University Press, 1975

### BACKGROUND

Desalination is a process for removing dissolved minerals from water. A number of technologies developed over the years include reverse osmosis, distillation, electrolysis, and vacuum freezing. This invention concerns a distillation process for sea water. Pages 284, 286, and 287 Of Reference 3 depict schematic drawings of apparatus for distillation means currently in use; Reference 1 depicts a recent patent of a distillation process found during a search of uspto.gov, classifications C02F and B01D.

This invention is concerned with a process in which sea water evaporates to salt-free steam for expansion in a turbine to produce salable energy prior to condensation and returning to the sea at a temperature and salinity harmless to sea life.

### BRIEF DESCRIPTION OF DRAWINGS

FIG. 1 shows schematically the components of the apparatus in its basic embodiment for producing fresh water and salable energy from sea water and exhausting brine to the sea at temperature and salinity without harm to sea life.

FIG. 2 depicts a second embodiment, an alternate method for desalination. This is a preferred embodiment for two reasons: (1) it is capable of producing salable energy significantly more than that of the basic configuration and (2) salt-free steam is evaporated from sea water at a temperature less prone to deposit scale.

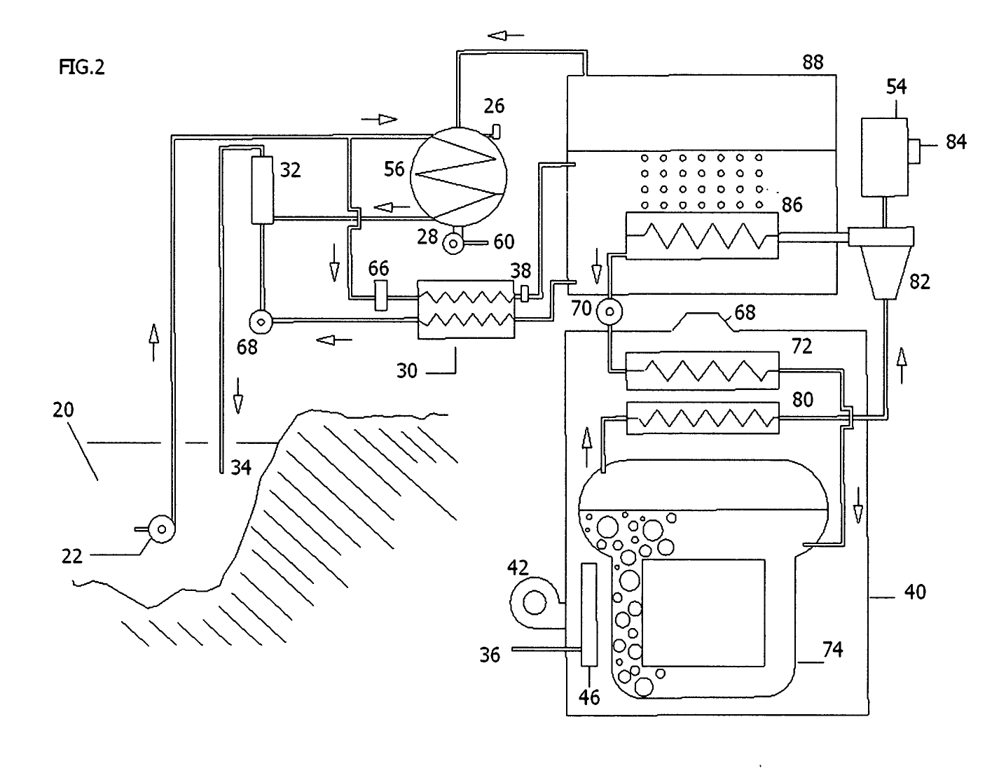

A third embodiment consisting of a desalination process performed at positive pressure instead of the vacuum described in embodiment 2. Somewhat different hardware results but no new principles; the operating temperatures are higher, hence the thermal efficiency of the energy process is lower and the temperature of sea water evaporation occurs at 212 degrees F. This embodiment is not described in detail nor shown in a drawing in this document; the hardware changes involved are obvious to one familiar with steam power technology.

### SUMMARY OF THE DISCLOSURE

The invention consists of a unique process, using apparatus consisting of components consistent with current technology to produce fresh water and salable energy while exhausting brine to the sea at temperature and salinity harmless to sea life. Salable energy as used herein means electrical energy produced by a generator in excess of that required to operate the pumps and blower.

### DETAILED DESCRIPTION OF THE INVENTION IN ITS BASIC EMBODIMENT

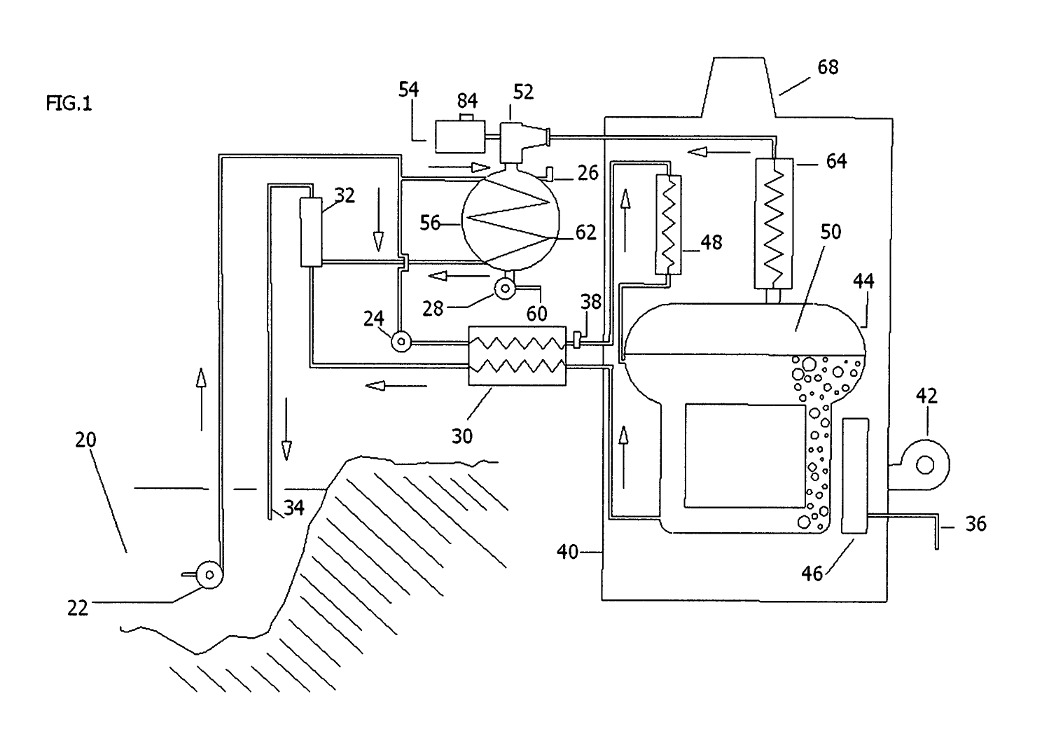

As shown in the schematic drawing of FIG. 1, sea water 20, that Reference 3 contains 3.5% salinity, enters submersible pump 22 which delivers it to the apparatus on shore where it divides, the larger portion delivered to a cooling coil 62 of condenser 56, and the smaller portion to pump 24 where its pressure is increased sufficiently to pass through a counterflow heat exchanger 30 where its temperature is increased as the exiting brine cools. Temperature sensor 38 provides a measure of the percentage of water evaporated to the quantity entering. The water entering furnace 40 containing a gas-fired burner 46 and three additional low pressure components: (1) a water heater 48, (2) a boiler 44, maintained at a temperature not to exceed 250 degrees F. so as to avoid depositing scale, and (3) a steam heater 64,

a turbine 52 where steam expands to the vacuum maintained in the condenser, producing energy accessible at receptacle 84 of generator 54,

a vacuum pump which removes non-condensable gases from the condenser,

a pump 28 which delivers distilled water at desired pressure at outlet 60,

an ejector 32 which dilutes brine exiting the heat exchanger with the copious flow from the condenser coil and discharging the mixture to the sea at outlet 34. A drawing of an ejector appears on Page 9-99 of Reference 2,

a blower 42 which supplies combustion air to the burner and which exits through flue 68, cooling as it rises.

### DESCRIPTION OF THE PREFERRED EMBODIMENT

### Energy Production

Energy production in the second embodiment is accomplished without the use of sea water; water that has been conditioned to be free from gases and minerals that deposit scale begins a conventional steam power cycle using high pressure and high temperature steam for maximum thermal efficiency. Water entering pump 70 is delivered at high pressure to furnace 40, containing a burner 46 heated with gas from tube 36, and containing three additional high pressure components: (1) a water heater 72, (2) a boiler 74, and (3) a steam heater 80. Steam exiting the furnace enters a high pressure turbine 82 where it expands to the vacuum maintained in coil 86; there it condenses in an isothermal process, the heat released supplying heat to vaporize sea water, also in an isothermal process, to salt-free steam in chamber 88, completing the cycle. The coil, made from a metal of high conductivity such as copper, remains at a temperature midway between that of the turbine exhaust and that of the chamber, a temperature that allows the latent heat of condensation to provide the latent heat of evaporation, energies that are very nearly equal.

Page 9-91 of Reference 2 contains Table 1 that lists customary design conditions for steam condensers; adherence to this table would result in a condenser steam temperature below 105 degrees F. (a similar temperature for the chamber since they communicate), and a temperature in the coil below 160 degrees F. (a saturation pressure of 4.74 psia). This results in a maximum temperature for sea water evaporation well below that which experience has shown to be likely to deposit scale. Table 3 on Page 9-94 lists 5 degrees F. as an acceptable temperature rise of cooling water.

### Desalination Process

Sea water 20 enters submersible pump 22 which delivers it to coil 62 where it serves as the heat sink to condense steam to distilled water. A smaller portion passes through orifice 66 where its pressure is reduced to a vacuum, passing through the counterflow heat exchanger 30 where it is heated by the brine exiting from the bottom of the chamber. The chamber is maintained at a temperature between that of the turbine exhaust and the sea which serves as the heat sink for condensing the steam evaporated from sea water.

The heat released from the coil immersed in sea water in the chamber evaporates a portion of the water to salt-free steam; the remainder, now brine, migrates to the bottom of the chamber and exhausts to the heat exchanger where it is cooled to near that of the sea. It then enters a pump 68 where its pressure is increased sufficiently to enter the nozzle of the ejector 32 and dilute the copious flow from the condenser and discharge the solution at outlet 34 at a temperature of about 5 degrees F. above that of the sea and a salinity of approximately 3.6%.

Steam from the chamber enters the condenser where it condenses to distilled water and then exhausts to pump 28 and outlet 60.

1-9. (canceled)

10. A process for producing fresh water and salable energy without environmental harm, using components of existing technology,
a. a technique for removing water from the sea, removing the salt from a small portion, and returning the remainder to the sea at a temperature and salinity only slightly altered;
b. evaporation of a small portion of that removed using heat from a gas-fired burner;
c. production of energy from a steam driven turbine;
d. production of distilled water by condensing salt-free steam in a condenser cooled by the larger portion of that removed from the sea

11. A simple means, described as basic embodiment, for performing claim 1 by
a. use of a low pressure boiler to evaporate salt-free steam at a temperature below that likely to deposit scale;
b. heating the steam before expanding it in a low pressure turbine;
c. exhausting the steam to the condenser where it is condensed to distilled water

12. A superior means for performing claim 1, described as the preferred embodiment by
a. water, treated to be free of minerals capable of depositing scale cycles in a conventional high pressure process to produce significantly more energy;
b. exhaust steam is condensed inside a coil immersed in seawater in a chamber in an isothermal process; the condensed water is pumped to a high pressure to commence a new cycle;
c. the latent heat released transfers to the cooler inner wall of the coil and transfers to the outer wall by conduction of the high conductivity copper material;
d. heat transfer from the outer wall evaporates a portion of the surrounding sea water in an isothermal process due to its lower temperature;
e. the salt-free steam enters the condenser where it condenses to distilled water in an isothermal process, transferring the latent heat to the cooling water in the condenser tubes;
